(19) United States
(12) Patent Application Publication
(10) Pub. No.: US 2005/0079127 A1
(43) Pub. Date: Apr. 14, 2005

(54) Method and apparatus for destruction of liquid toxic wastes and generation of a reducing gas

(75) Inventors: Ricardo Viramontes-Brown, San Pedro Garza Garcia (MX); Juan Antonio Villarreal-Trevino, Guadalupe (MX)

Correspondence Address: FROMMER LAWRENCE & HAUG, 745 FIFTH AVENUE- 10TH FL., NEW YORK, NY, 10151, US

(73) Assignee: HYLSA, S.A. DE C.V., Nuevo Leon (MX)

(21) Appl. No.: 10/918,963

(22) Filed: Aug. 16, 2004

Related U.S. Application Data
(60) Provisional application No. 60/495,924, filed on Aug. 18, 2003.

(51) Int. Cl. C01B 3/24; B01J 10/00

(52) U.S. Cl. 423/650; 422/194

(57) ABSTRACT

The invention relates to a method and system for destroying liquid toxic materials for example polychlorinated biphenyls, and producing a reducing gas. In a preferred embodiment, harmful intermediates are not generated when the toxic materials are destroyed due to the reducing atmosphere produced by partial combustion with a molecular-oxygen-containing gas and steam. Liquid materials containing high concentrations of PCB's are mixed with non-toxic hydrocarbons for sustaining an autothermic reaction. The efficiency of the PCB's destruction process exceeds the required environmental regulations and produces a useful reducing gas which can be utilized as a synthesis gas in chemical processes or as a fuel for heat and/or power production.

### FIELD OF THE INVENTION

The present invention relates to the handling and disposal of toxic wastes. More particularly, the present invention relates to transforming toxic waste materials, such as halogenated-organic-compounds having liquids and solids, to a non-toxic reducing gas. The non-toxic reducing gas can be utilized as a synthesis gas, as a fuel or as a chemical reducing agent in, for example, the chemical reduction of iron oxides into metallic iron.

Documents cited in this text, and all documents cited or referenced in the documents cited in this text, are incorporated herein by reference. Documents incorporated by reference into this text or any teachings therein may be used in the practice of this invention. Documents incorporated by reference into this text are not admitted to be prior art. Furthermore, authors or inventors on documents incorporated by reference into this text are not to be considered to be “another” or “others” as to the present inventive entity and vice versa, especially where one or more authors or inventors on documents incorporated by reference into this text are an inventor or inventors named in the present inventive entity.

### BACKGROUND OF THE INVENTION

Hazardous and environmentally damaging substances, such as polychlorinated biphenyls (PCB's), and their safe destruction are a major concern in the industrialized world. PCB's are one of the best known compounds referred to in the industry as POP's (persistent organic pollutants). Such pollutants also include waste pesticides such as DDT, and CFC's (chlorofluorocarbons), halogenated benzenes, halogenated phenols, halogenated alkanes, halogenated cycloalkanes, halogenated dioxins and halogenated dibenzofurans.

A number of methods for disposing of and destroying waste toxic materials have been proposed. See for example a report titled “Destruction Technologies for Polychlorinated Biphenyls (PCBs)” by M. S. M. Muheebur Rahuman, Luigi Pistone, Ferruccio Trifiro and Stanislav Miertus (2002) (incorporated herein by reference). Some of the methods described in this report can be summarized as follows: (1) high temperature incineration with oxygen; (2) incineration in cement kilns; (3) super critical oxidation; (4) electrochemical oxidation; (5) solvated electron technology; (6) chemical reduction reaction; (7) dehalogenation processes, and other complex technologies.

Incineration with oxygen is typically performed in rotary kilns at temperatures of about 870° C. to 1200° C. Destruction efficiencies up to 99.9999% can be achieved. Liquid wastes with PCB concentrations above 50 ppm are incinerated in some places if such incineration complies with a residence time of at least of 2 seconds at 1200° C. and 3% excess oxygen in the stack gases.

One of the problems associated with the incineration is atmospheric oxygen control in order to prevent formation of dioxins and benzofurans which are also toxic. Treatment of wastes in cement kilns also involves some kind of incineration. Since they operate at temperatures above 1400° C. and the conditions therein are highly alkaline, cement kilns decompose chlorinated organic wastes. The quantity of waste is, however, limited to a small fraction of the fuel requirements of the kiln and no liquid or solid residues are generated since all residues come out of the kiln bound to the product. When operated properly, destruction of chlorinated compounds can be 99.00% complete without affecting the quality of the exhaust gas. Not all cement kilns, however, meet the required conditions for this use and not all companies are willing to handle waste products in their normal cement production operations.

Chemical reduction technologies involve the gas-phase chemical reduction of organic compounds with hydrogen at temperatures above about 850° C. This process has been applied for destruction of a variety of organic compounds such as chlorophenols, dioxins, chlorobenzenes, pesticides, herbicides and insecticides. These compounds are converted to methane. About 40% of the methane produced is then converted to hydrogen and CO through the water gas shift reaction, and the remaining methane is converted to hydrogen in a catalytic steam reformer which is combined with the waste oil so that the oxidation reaction takes place in a reducing atmosphere devoid of oxygen. In this way the possibility of dioxin and furan formation is said to be eliminated.

U.S. Pat. No. 3,140,155 to J. A. Cull et al. relates to a process and furnace for hydrogen chloride recovery from chlorinated residues such as hexachloro-cyclopentadiene, and trichlorobenzenes. Although Cull's process involves the reaction of chlorinated compounds with air/oxygen and steam, the gases produced from such reaction are not intended to comprise significant proportions of hydrogen and CO but only to obtain as much hydrogen chloride as possible.

U.S. Pat. No. 3,305,309 to R. G. Woodland et al. relates to a process and apparatus for converting halogenated organic materials into gaseous products comprising carbon dioxide and hydrogen halide. The halogenated organic compounds are reacted with air or oxygen and steam in a tubular burner wherein an intimate mixture of steam and the halogenated organic material is effected by passing the steam under pressure through a restricted zone into an expanded zone. The halogenated material is introduced into the expanded zone and brought into contact with the steam. The mixture is then atomized by passing it through a constricted zone into an expanded zone where the mixture is combined with oxygen or air. Preferably the atomized mixture is enveloped in the gaseous medium as it is injected into the combustion zone.

U.S. Pat. Nos. 4,074,981 and 4,468,376 relate to processes for disposing of a halogenated organic material by partial oxidation of said organic material together with a hydrocarbonaceous material and a nitrogen compound with a free oxygen-containing gas. The partial oxidation produces a synthesis gas containing hydrogen, carbon monoxide, carbon dioxide, hydrogen cyanide, hydrogen halide and ammonia. The synthesis gas produced is contacted with water containing additional ammonia in order to neutralize the hydrogen halide.

U.S. Pat. No. 4,631,183 to Lalancette et al. relates to a process for the destruction of toxic organic halogenated substances comprising treating in a reaction chamber under a reductive atmosphere and at high temperatures in the range from 1000° C. to 1600° C. a mixture of a toxic halogenated substance, carbon and a carbonate or bicarbonate of an alkali metal whereby the vapors of the alkali metal are generated in situ to cause total degradation of the toxic substance into non-toxic components. Carbon monoxide is formed during the process and it is oxidized to carbon dioxide in a separate combustion chamber. The resulting gases from this process are fully oxidized, but a useful gas comprising hydrogen and carbon monoxide is not produced.

DE 41 09 231 A1 relates to a process for transforming waste halogenated hydrocarbons to produce a gas containing hydrogen and carbon monoxide by partial oxidation with oxygen in a flame reaction. The hydrocarbon is combined with oxygen under pressure. The gases produced are cooled down and thereafter are passed through a catalytic converter to transform the gases into a desired final composition through the well-known water gas shift reaction. The hot gases are quenched with water having an alkaline additive. The process of this patent, however, presents a number of drawbacks, e.g. the halogenated hydrocarbon is reacted with oxygen only without a temperature moderator as steam, therefore, the flame temperature is extremely high requiring a very specialized refractory lining. The carbon dioxide content in the gases produced by partial oxidation is relatively high, requiring an additional reactor to convert a portion of that carbon monoxide to hydrogen. The water needed for such water-shift reaction is added by evaporation of the quenching water. This method of supplying the water is not efficient because it depends on the saturation conditions of the gases.

U.S. Pat. No. 4,402,274 relates to a partial oxidation of the toxic material followed by quenching of the reaction products.

U.S. Pat. No. 4,140,066 to Rathjen et al. relates to a process for the thermal decomposition of polychlorinated organic compounds such as polychlorinated phenyls and biphenyls comprising heat treating said compounds in a flame, in a high-turbulence combustion chamber in a pulsating spiral flow at a temperature of at least about 850° C. with a residence time of at least 0.1 seconds in the presence of an excess of at least about 5% by weight of oxygen based on the carbon to be burnt, the PCB being present in the fuel feed in about 0.1 to 30% by weight. The process of this patent is a full combustion process and does not produce a reducing gas as a result of the oxidation reaction.

U.S. Pat. Nos. 4,819,571 and 5,050,511 to Hallet relate to a system for the destruction of organic waste material (PCB's and related waste organic matter) which comprises subjecting the waste material to reduction with hydrogen at a temperature above 600° C. with indirect heating of the reduction chamber, and thereafter oxidizing the hot resultant reaction mixture at a temperature above 1000° C. The system includes a reduction vessel and an adjacent combustor for the oxidation reaction. The process of this patent comprises a two-stage method requiring at least two high-temperature reactors and a hydrogen generator.

U.S. Pat. Nos. 5,449,854 and 5,609,104 to Yap relate to a method and an incinerator for incinerating halogenated organic compounds. The process comprises two steps, one wherein an auxiliary fuel, for example natural gas, is partially combusted to generate hydrogen and a second step wherein the gases produced in the first step are fully combusted with additional oxygen. This two-step process purportedly minimizes formation of halogenated furans and dioxins. The process of Yap is complex and is intended to incinerate the halogenated compounds, not to produce a useful gas.

U.S. Pat. No. 4,851,600, British patent 1,350,727 and German patent DE 41 25 518 also relate to processes for destruction of halogenated organic materials wherein said materials are fully combusted in multiple combustion steps or in the presence of metals for capturing chlorine.

U.S. Pat. Nos. 4,869,731, 5,074,890 and 4,950,309 relate to a process for the thermal decomposition of toxic refractory organic substances. Toxic substances are contacted with an oxidizing medium and steam at a temperature in the range of 2500° F. (1371° C.) to 3200° F. (1760° C.) for a period of 5 to 500 milliseconds in a reaction chamber. The process of this patent requires extremely high temperatures and the reaction time is very short. Therefore, the materials are also contacted with incandescent carbon or refractory.

U.S. Patent Publication No. 2002/0098133 A1 relates to processes for the conversion of halogenated materials to one or more useful products. These products can be a useful acid and/or a product synthesis gas.

U.S. Pat. Nos. 2,928,460, 3,462,250, 3,545,926, 3,743,606 and 3,874,592 relate to burners for partial oxidation of hydrocarbons. These patents purportedly provide for designs for achieving atomization of the liquid hydrocarbons by impinging a gaseous stream of an oxidant with a separate stream of the hydrocarbon at the tip of the burner. These burner designs, however, rely more on the atomization of the liquid rather than favoring a dispersed flow pattern of the liquid and gas phases, and present the disadvantage of not producing an efficient non-dispersed coherent flame.

Large amounts of contaminated materials, such as those containing PCBs, and other toxic wastes are currently stored at high cost in many places all over the world pending destruction. This poses grave environmental risks. The prior art methods of destroying contaminated materials, however, have a number of drawbacks. For example, the processes in the art do not completely destroy the PCB's. Further, the cost of operation is high; typically without any off-setting economic benefit and the use of complex and costly equipment and multi-step reactions are required. Additionally, harmful intermediates can be produced.

Thus, a need exists in the art for the destruction of the toxic materials by partial oxidation and generation of a reducing gas in a single reaction vessel. A need also exists in the art for an efficient and low-cost method of destroying such toxic materials without producing harmful or unwanted intermediates.

### OBJECTS AND SUMMARY OF THE INVENTION

Therefore an object of the invention can be to provide an efficient and low-cost process and equipment for destruction of toxic waste materials.

It is another object of the invention to provide a method and apparatus for producing a reducing gas which can be utilized as fuel or chemical reducing agent for example in the reduction of iron oxides.

It is yet another object of the invention to destroy toxic wastes, such as PCB's, without producing harmful intermediates, such as dioxins.

Other objects will be pointed out hereinafter or will become evident for those readers expert in the art.

In accordance with one embodiment of the present invention, therefore, a method is provided for the destruction of a toxic material without producing harmful intermediates, having the steps of destroying said toxic material in a partial oxidation reaction in a heated reaction vessel by contacting a liquid hydrocarbon material comprised of said toxic material with steam and an oxygen-containing source, and producing a reducing gas thereby comprised of hydrogen and carbon monoxide.

In accordance with another embodiment of the present invention, a system is provided for the destruction of toxic waste materials and producing a reducing gas comprising hydrogen and carbon monoxide, the system having a partial combustion chamber; a burner where a stream of oxygen, steam and said toxic materials are reacted producing high-temperature flame gases within said partial combustion chamber; and gas cooling means for quenching said flame gases.

In this disclosure, “comprises,” “comprising” and the like can have the meaning ascribed to them in U.S. Patent Law and can mean, “includes,” “including” and the like.

### BRIEF DESCRIPTION OF THE DRAWINGS

In this specification and the accompanying drawings, some preferred embodiments of the invention are shown and described, and various alternatives and modifications thereof have been suggested. It is to be understood that these are not intended to be exhaustive and that many other changes and modifications can be made within the scope of the invention.

The suggestions herein are selected and included for purposes of illustration in order that others skilled in the art will more fully understand the invention and the principles thereof and will thus be enabled to modify it in a variety of forms, each as may be best suited to the conditions of a particular use.

In the following detailed description, reference will be made to the accompanying drawings, wherein:

FIG. 1 is a schematic diagram of the process for processing the toxic waste hydrocarbons.

FIG. 2 is a schematic diagram of the burner utilized for partially combusting the toxic waste hydrocarbons.

### DETAILED DESCRIPTION OF ILLUSTRATIVE PREFERRED EMBODIMENTS OF THE INVENTION

Typically, destruction of toxic wastes follows a process whereby harmful intermediates are produced. The present invention advantageously destroys toxic materials, such as PCB's, without producing harmful intermediates, such as dioxins and furanes.

For example, it has hereby been unexpectedly discovered that by making the temperature of the refractory higher than that of the incoming materials, the efficiency of the partial combustion reaction is increased. Further, by limiting the oxygen feed to less than the stoichiometric amount for full combustion, toxic intermediates are not generated. Instead, one of the end products of the present invention is HCl, which can easily be neutralized with NaOH. Typically, the refractory is maintained at a temperature above about 650° C., preferably at above about 750° C., depending on the type of material being gasified. Further, by heating the refractory, fuel is saved. Indeed, the art uses extra fuel to maintain the flame of the refractory, which the present invention avoids.

The instant invention by, for example, using steam as the reducing source, by regulating the oxygen ratio and by monitoring temperature, achieves a 99.9999% efficiency in reducing toxic wastes. Further, use of steam is cheaper than using typical hydrocarbon fuels, and the steam can be a byproduct of a concurrent, separate reaction.

In a preferred embodiment, the present invention carries out the combustion reaction by mixing steam and oxygen, which mixture envelopes a jet of PCB containing liquid in a pipe with such dimensions as to meet the conditions for achieving a disperse two-phase flow of within said pipe, by controlling the velocity of the fluids in said pipe so that a controlled, narrow, coherent and stable flame is produced within a combustion chamber surrounding the tip of said pipe.

The present invention can be applied to virtually any hydrocarbon and any organic contaminant including, but not limited to, PCB's, dioxins, pesticides and solvents at any concentration. Typical hydrocarbons include PCB-contaminated oil of electrical equipment, pesticide wastes and other waste oils and hydrocarbons from the petrochemical industry. The present invention also avoids the need of a catalytic converter typically used in generating a process gas from hydrocarbons.

The present invention provides for, for example, a method for the destruction of a toxic material comprised in a liquid hydrocarbon without producing harmful intermediates. The steps of the method include mixing said liquid hydrocarbon comprising said toxic material with steam and a molecular oxygen-containing gas in a flow channel and regulating the flow rates of said liquid hydrocarbon and said steam and oxygen gases so that a velocity of the mixture of liquid and gas at the outlet of said flow channel is above about 40 m/s, introducing said mixture of liquid and gas in a reaction vessel having a refractory lining at a temperature above about 650° C., maintaining said producing high-temperature gases comprising molecular hydrogen within said reaction vessel at least about 2 seconds; maintaining a temperature at the outlet of said reaction vessel above about 1000° C.; and cooling and washing said gaseous products with water. As a result of the method, a reducing gas is produced comprising hydrogen and carbon monoxide substantially free of said toxic material as a result of the partial combustion of said liquid hydrocarbon. The toxic material is comprised of one or more of the substances: polychlorinated biphenyls, pesticides, chlorofluorocarbons, halogenated benzenes, halogenated phenols, halogenated alkanes, halogenated cycloalkanes, halogenated dioxins or halogenated dibenzofurans or combinations thereof. In a preferred embodiment, the liquid hydrocarbon is oil.

Preferably, the velocity of the mixture of liquid and gas at the outlet of said flow channel is above about 50 m/s. Further, the refractory lining of said reaction vessel is preferably maintained at a temperature above about 750° C. The liquid hydrocarbon, in turn, preferably contains less than about 50% by weight of polychlorinated biphenyls.

In one embodiment, the liquid hydrocarbon containing polychlorinated biphenyls is mixed with hydrocarbons not containing polychlorinated biphenyls before introducing said contaminated hydrocarbon in said reaction vessel, in order to secure the autothermic partial combustion of the mixture of hydrocarbons. Preferably, the mixture of hydrocarbons has less than about 50% by weight of polychlorinated biphenyls before being introduced into said reaction vessel.

The mixture of hydrocarbons may have less than about 10% by weight of polychlorinated biphenyls before being introduced into said reaction vessel. Further, the water used for said gas cooling is typically mixed with an alkaline compound for neutralizing the acidity derived from chlorine absorption by said water. Further still, the water used for said gas cooling is preferably treated for concentrating and recuperating HCl derived from chlorine absorption by said water.

The present invention also provides for a system for the destruction of liquids comprising toxic materials and producing a reducing gas comprising hydrogen and carbon monoxide. In a preferred embodiment, the system includes a partial combustion chamber, said combustion chamber having a refractory lining adapted to being heated and maintained at high temperature whereby flame gases are produced, and said chamber having an inlet and an outlet; a flow channel having a length to diameter ratio of at least about 4, and where a stream of oxygen, a stream of steam and a stream of liquid comprising said toxic materials are intimately mixed; said flow channel being in communication with said combustion chamber inlet; and gas cooling means communicating with said combustion chamber outlet for quenching said flame gases. Preferably, the length to diameter ratio of said flow channel is at least about 30.

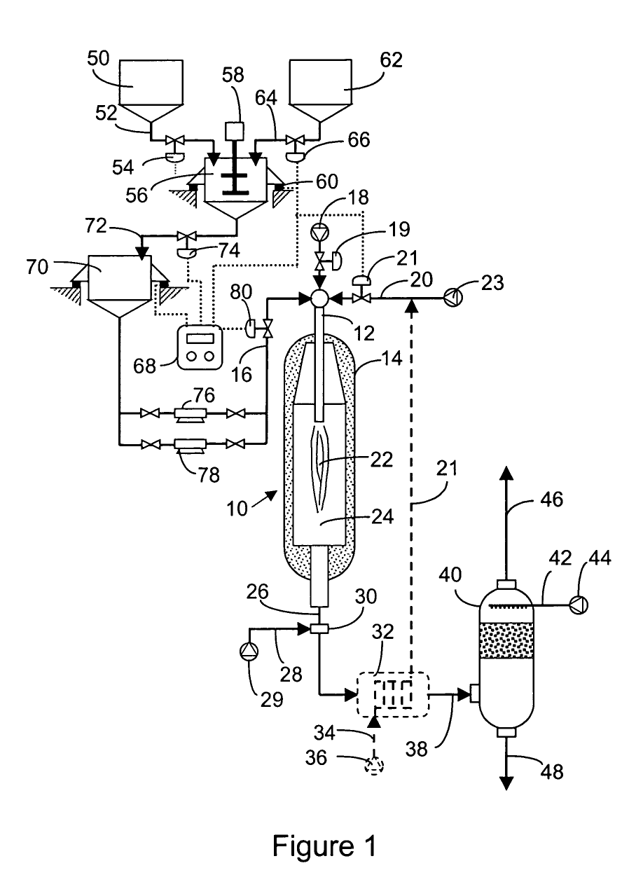

A preferred embodiment of the invention is herein described with reference to FIG. 1, wherein numeral 10 generally designates a partial combustion reactor comprising a burner 12 and a refractory lined wall 14. A stream of liquid hydrocarbon waste 16 is combined in said burner with an oxygen-containing gas 18, which can be pure oxygen, air or oxygen-enriched air in various proportions, depending on the desired quality of the product gas. Steam 20 supplied from a suitable source 23, or optionally produced in boiler 32 and fed through pipe 21, is injected to the burner 12 so that the hydrocarbon 16, oxygen 18 and steam 20 react and produce a high temperature flame 22 within the reaction space 24 of reactor 10. Reaction space 24 is designed according to the feeding rate of reactants so that a residence time of the flame gases exceeds about 2 seconds, preferably about 3 seconds, at a temperature higher than about 1600° C. The high temperature flame reaction destroys the complex molecules of the halogenated compounds, under a reducing atmosphere. The oxygen-containing gas is fed to burner 12 in an amount less than the amount stoichiometrically needed for complete combustion of the hydrocarbons.

In a preferred embodiment of the invention, the gases produced by burner 12 exit reactor 10 through pipe 26 and are quenched down to a temperature below about 300° C. by contact with cooling water 28 from a suitable source 29 in quench orifice 30. Cooled gases and water then optionally pass through heat exchanger 32 where steam is produced from water 34 from source 36, and fed to burner 12 through pipes 20 and 21. The reducing gas 38 is then treated in a scrubber 40 where it contacts water 42 from source 44. Hydrochloric acid formed by combination of chlorine atoms of the polychlorinated biphenyls with hydrogen produced by the partial combustion of the hydrocarbons, is absorbed by water and is extracted in solution with water 48. This acid water may be further treated for concentrating the hydrochloride acid for sale or may be treated with sodium hydroxide for neutralization thereof.

The reducing gas 46 produced from the contaminated hydrocarbons may be utilized as synthesis gas, as a chemical reactant in other chemical processes or as a fuel for steam or power production.

Liquid hydrocarbons contaminated with PCB's are mainly contained in electrical equipment, e.g. transformers, capacitors and the like, at a variety of concentrations. Concentration of PCB's in the refrigerating oils of electrical equipment may be below 50 ppm (parts per million) up to almost pure PCB's. One of the main properties of PCB's is their chemical stability and therefore they do not react easily with oxygen due to the strong chlorine chemical bonds in the molecule and their low calorific value. Materials with high concentrations of PCB's may not sustain a stable reaction with oxygen, and therefore it is recommended to mix them with other non-contaminated hydrocarbons, thus lowering the concentration to levels below about 600,000 ppm (60% by weight), and preferably below about 300,000 ppm and more preferably below about 110,000 ppm.

Referring again to FIG. 1, contaminated hydrocarbons are transferred from holding tank 50 through pipe 52 provided with valve 54 to mixing tank 56. Mixing tank 56 is provided with stirring means 58 to provide for a homogeneous composition of the materials fed to reactor 10, and with load cells 60. Hydrocarbons contaminated with PCB's are transferred from holding tank 62 through pipe 64 provided with valve 66 to mixing tank 56. Signals from load cells 60 are used by controller 68 for preparing batches of hydrocarbons with predetermined levels of concentration of PCB's. After mixing, hydrocarbons are passed to feed tank 70 through pipe 72 provided with valve 74. From feed tank 70 hydrocarbons are fed to burner 12 by any one of pumps 76 or 78 through pipe 16 provided with control valve 80.

The proportions of steam, oxygen and hydrocarbons are controlled by controller 68 and control valves 19, 21 and 80, according to predetermined values of process parameters comprising the desired minimum temperature and residence time in the reaction chamber 24 to destroy the PCB molecules, resulting in up to and including full destruction of the toxic materials. The temperature for destruction of PCB's at the outlet of reactor 10 is in the range from about 1000° C. to about 1100° C. Flame temperatures may reach more than 2000° C., but the average temperature of the gases after endothermic reactions take place to produce the reducing gas—with a typical composition of about 45.6% hydrogen; about 34.6% carbon monoxide; about 18.9% carbon dioxide; about 0.6% methane; about 0.4% nitrogen; and traces of other materials—lower the gases temperature to about 1000° C. This gases temperature may be regulated by the proportion of steam to oxygen and hydrocarbons. The reducing character of the gases within reactor 10 prevents dioxins and furans from forming, thereby assuring a safe operation of the PCB's destruction process, in contrast with the incineration processes where an excess of oxygen propitiates such formation unless the hot gases are immediately and rapidly quenched.

The invention also comprises a burner or injection lance to produce a coherent flame with the mixture of contaminated hydrocarbons, steam and oxygen and feed this mixture into the high-temperature reaction chamber 24 of reactor 10. Any burner that provides for atomization of liquids so that hydrocarbons are not cracked by the high temperature of the reaction chamber forming soot and lowering the gasification efficiency can be used. In a preferred embodiment, a tube-in-tube burner is used to produce a long coherent flame favoring full contact and mixture of the reactants.

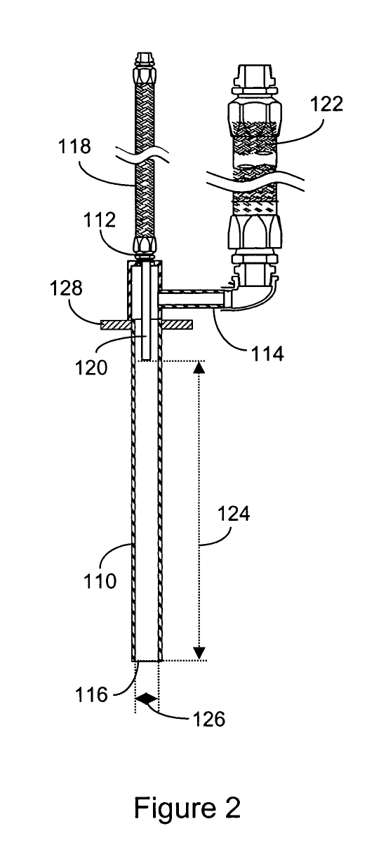

Referring to FIG. 2, a burner 110 for the partial combustion of hydrocarbons, useful for securing destruction of toxic compounds, is provided with a first inlet 112 and second inlet 114 and outlet 116. The burner is also provided with flange means 128 for fixing to reactor 10 as well known in the art. Liquid hydrocarbon is fed through first conduit 118 to said first inlet 112 and then is injected through inner pipe 120 into outer pipe 110. A mixture of steam and a free-oxygen-containing gas is fed through second conduit 122 to second inlet 114 and flows along with liquid hydrocarbon through outer pipe 110.

By having a ratio of length 124 to diameter 126 of the burner pipe 110 greater than or equal to 4, preferably in the range of about 30 to about 36, the liquid hydrocarbon and the gaseous mixture of steam and oxygen develop a flow pattern known as dispersed flow, e.g. a mixture of small liquid droplets entrained by the gas. This intimate contact of reactants minimizes soot formation and increases the efficiency of the gasification process. For such dispersed flow pattern to develop velocity of the gaseous phase is one important consideration, therefore, the inner diameter of pipe 110 is selected according to the rate of hydrocarbon feed so that the actual average velocity of the gas is from about 40 m/s to about 60 m/s, preferably from about 45 m/s to about 55 m/s.

Typically 1 NCM of steam/oxygen gas required for 1 kg of hydrocarbon. Once the flow rate of reactants is defined, the inner diameter and length of pipe 110 are selected.

The burner-lance of the present invention for performing the partial combustion of the hydrocarbons provides an intimate contact of the liquid and gaseous phases through a pipe in contrast to the structures of burners of the prior art which rely on directing the stream of gas so that it impinges in a separate stream of liquid. The burner of the invention produces a compact coherent flame with a high reaction efficiency because the velocity vector of the mixture is sufficient to project it freely into the reaction chamber, much like a long rifle cannon directs a bullet. The prior art, by contrast, directs separate streams of liquid and gas in several directions at the tip of the burner in order to promote impingement thereof one upon the other and dispersing the particles in the reaction space.

It has been found that the burner of the present invention may also be utilized for gasification of hydrocarbons other than oils contaminated with PCB's. For example, the invention may also be applied for gasification of a slurry of ground solid hydrocarbon, for example pet-coke or coal and for destruction of other type of toxic materials, for example, insecticides, Freon gases, solvents, chloroflurocarbons, biocides and hospital wastes.

The present invention is additionally described by way of the following illustrative, non-limiting Examples that provide a better understanding of the present invention and of its many advantages.

### EXAMPLES

The following examples are set forth to illustrate various embodiments in accordance with the present invention. The following examples, however, are in no way meant to limit the present invention.

### Example 1

A burner of 3/4 inches inner diameter was used for gasifying three different types of liquid hydrocarbons without toxic materials and producing a useful reducing gas as follows:

| | | Flow rate | | |
|---|---|---|---|---|
| | Unit | Run 1 | Run 2 | Run3 |
| Hydrocarbon: | (Kg/Hr) | 54.0 | 56.3 | 52.0 |
| Oxygen: | (NCM/Hr) | 54.0 | 34.4 | 47.2 |
| Steam: | (NCM/Hr) | 35.0 | 32.7 | 37.0 |

The hydrocarbons were treated according to the invention producing a reducing gas in the amount and composition (dry basis) shown below:

| | | | | |
|---|---|---|---|---|
| Reducing gas: | (NCM/Hr) | 142.0 | 104.0 | 143.2 |
| H2: | % vol. | 47.90 | 45.7 | 46.8 |
| CO: | % vol. | 30.23 | 24.1 | 27.0 |
| CO₂: | % vol. | 18.79 | 24.5 | 19.9 |
| CH₄: | % vol. | 2.61 | 5.3 | 6.0 |
| N₂: | % vol. | 0.47 | 0.4 | 0.2 |

### Example 2

Oil contaminated with PCB's was destroyed according to the invention in two runs, one at a PCB concentration of 5% by weight (50,000 ppm) and the other at a PCB concentration of 10% by weight (100,000 ppm).

The values of process parameters were as follows:

| | Unit | Run 1 | Run 2 | Run 3 |
|---|---|---|---|---|
| Concentration of PCB's | | 0% | 5% | 10% |
| Hydrocarbon: | (Kg/Hr) | 56.9 | 58.2 | 60.6 |
| Oxygen: | (NCM/Hr) | 62.8 | 61.5 | 62.8 |
| Steam: | (NCM/Hr) | 74.8 | 73.4 | 77.0 |
| Temperature: | ° C. | 1241 | 1268 | 1298 |
| Pressure: | Kg/cm2 gage | 3 | 3 | 3 |

The hydrocarbons were treated according to the invention producing a reducing gas in the amount and composition on a dry basis shown below:

| | | | | |
|---|---|---|---|---|
| Reducing gas: | (NCM/Hr) | 142.6 | 134.8 | 132.2 |
| H₂: | % vol. | 46.65 | 46.09 | 45.60 |
| CO: | % vol. | 33.44 | 34.19 | 34.56 |
| CO₂: | % vol. | 18.71 | 18.54 | 18.86 |
| CH₄: | % vol. | 0.97 | 0.92 | 0.62 |
| N₂: | % vol. | 0.23 | 0.26 | 0.36 |
| Nitrogen Oxides: | mg/m3 | 2.5 | 2.9 | 4.2 |
| SO₂ | mg/m3 | 7.5 | 8.7 | 4.4 |
| HCl: | mg/m3 | <0.58 | <0.57 | <0.29 |
| Total PCB's | mg/m3 | 2.23E−0 | 53.4E−05 | 8.97E−04 |
| Dioxins and Furanes | ng-EQT/m3 | 6.5E−06 | 8.1E−06 | 7.1E−06 |

Values of some process parameters were:

| | | | | |
|---|---|---|---|---|
| Temperature: | ° C. | 1241 | 1268 | 1298 |
| Pressure: | Kg/cm2 gage | 3 | 3 | 3 |

The extremely low values of PCB 's in the product gases show that the invention is very efficient in the destruction of PCB's and that the reducing atmosphere created by the partial combustion and the intimate mixing of the reactants do not favor formation of dioxins and furanes.

The cooling water employed for cooling and washing the reducing gases in cooler 40 was analyzed giving the following results:

| Concentration of PCB's | | 0% | 5% | 10% |
|---|---|---|---|---|
| Chlorides in make-up water: | mg/l | 58 | | |
| Chlorides at cooler inlet | mg/l | 66 | 651 | 1864 |
| Chlorides at cooler outlet | mg/l | 74 | 756 | 1850 |
| PCB's at cooler outlet | mg/l | <0.002 | <0.002 | <0.002 |
| Dioxins + Furanes | ng/l | 9.4E−05 | 1.5E−04 | 8.4E−03 |
| cooler outlet | | | | |

Comparison of efficiency and emission levels of the process of the invention with the levels of contaminants permitted according to U.S. Regulations:

| Parameter | Unit | 0% | 5% | 10% | U.S. Reg |
|---|---|---|---|---|---|
| Efficiency PCB | % | — | 99.9999998 | 99.99999972 | 99.9999 |
| destruction | | | | | (min) |
| Dioxins and Furanes | ngEqt/m3 | 6.505E−06 | 8.100E−06 | 7.072E−06 | 0.5 |
| Suspended particles | mg/m3 | 6.3 | 2.1 | 2.7 | 30 |
| SO₂ | mg/m3 | 5.04 | 5.81 | 2.93 | 80 |
| Nitrogen Oxides | mg/m3 | 1.67 | 1.94 | 2.81 | 300 |
| Hydrogen chloride | mg/m3 | <0.039 | <0.038 | <0.019 | 15 |

Various modifications and variations of the described compositions, materials and methods of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art or in related fields are intended to be within the scope of the following claims.

1. A method for the destruction of a toxic material comprised in a liquid hydrocarbon without producing harmful intermediates, comprising the steps of:
mixing said liquid hydrocarbon comprising said toxic material with steam and a molecular oxygen-containing gas in a flow channel and regulating the flow rates of said liquid hydrocarbon and said steam and oxygen gases so that a velocity of the mixture of liquid and gas at the outlet of said flow channel is above about 40 m/s,
introducing said mixture of liquid and gas in a reaction vessel having a refractory lining at a temperature above about 650° C.,
maintaining said producing high-temperature gases comprising molecular hydrogen within said reaction vessel at least about 2 seconds;
maintaining a temperature at the outlet of said reaction vessel above about 1000° C.; and
cooling and washing said gaseous products with water,
wherein a reducing gas is produced comprising hydrogen and carbon monoxide substantially free of said toxic material as a result of the partial combustion of said liquid hydrocarbon.

2. The method according to claim 1, wherein said toxic material is comprised of one or more polychlorinated biphenyls, pesticides, chlorofluorocarbons, halogenated benzenes, halogenated phenols, halogenated alkanes, halogenated cycloalkanes, halogenated dioxins or halogenated dibenzofurans or combinations thereof.

3. The method according to claim 1, wherein said liquid hydrocarbon is oil.

4. The method according to claim 1, wherein said velocity of the mixture of liquid and gas at the outlet of said flow channel is above about 50 m/s.

5. The method according to claim 1, wherein the refractory lining of said reaction vessel is maintained at a temperature above about 750° C.

6. The method according to claim 2, wherein said liquid hydrocarbon contains less than about 50% by weight of polychlorinated biphenyls.

7. The method according to claim 2, wherein said liquid hydrocarbon containing polychlorinated biphenyls is mixed with hydrocarbons not containing polychlorinated biphenyls before introducing said contaminated hydrocarbon in said reaction vessel, in order to secure the autothermic partial combustion of the mixture of hydrocarbons.

8. The method according to claim 6, wherein said mixture of hydrocarbons has less than about 50% by weight of polychlorinated biphenyls before being introduced into said reaction vessel.

9. The method according to claim 7, wherein said mixture of hydrocarbons has less than about 10% by weight of polychlorinated biphenyls before being introduced into said reaction vessel.

10. The method according to claim 1, wherein the water used for said gas cooling is mixed with an alkaline compound for neutralizing the acidity derived from chlorine absorption by said water.

11. The method according to claim 1, wherein the water used for said gas cooling is treated for concentrating and recuperating HCl derived from chlorine absorption by said water.

12. A system for the destruction of liquids comprising toxic materials and producing a reducing gas comprising hydrogen and carbon monoxide, said system comprising: a partial combustion chamber, said combustion chamber having a refractory lining adapted to being heated and maintained at high temperature whereby flame gases are produced, and said chamber having an inlet and an outlet; a flow channel having a length to diameter ratio of at least about 4, and where a stream of oxygen, a stream of steam and a stream of liquid comprising said toxic materials are intimately mixed; said flow channel being in communication with said combustion chamber inlet, and gas cooling means communicating with said combustion chamber outlet for quenching said flame gases.

13. A system according to claim 12, wherein the length to diameter ratio of said flow channel is at least about 30.
